(19) United States
(12) Patent Application Publication
(10) Pub. No.: US 2020/0154111 A1
(43) Pub. Date: May 14, 2020

(54) IMAGE MAPPING METHODS, APPARATUSES, DEVICE, AND COMPUTER-READABLE MEMORY MEDIUM

(71) Applicant: PEKING UNIVERSITY SHENZHEN GRADUATE SCHOOL, Shenzhen (CN)

(72) Inventors: Ronggang WANG, Shenzhen (CN); Yueming WANG, Shenzhen (CN); Zhenyu WANG, Shenzhen (CN); Wen GAO, Shenzhen (CN)

(21) Appl. No.: 16/514,269

(22) Filed: Jul. 17, 2019

Related U.S. Application Data
(63) Continuation-in-part of application No. 16/478,607, filed on Jan. 6, 2020.

(30) Foreign Application Priority Data
Jan. 17, 2017 (CN) 201710031017.7

(51) Int. Cl. H04N 19/139; H04N 19/159; H04N 19/105; H04N 19/176

(52) U.S. Cl. CPC H04N 19/139; H04N 19/176; H04N 19/105; H04N 19/159

(57) ABSTRACT

The present disclosure provides an encoding method, a decoding method, an encoder, and a decoder, the encoding method comprises: performing interframe prediction to each interframe coded block to obtain corresponding interframe predicted blocks; writing information of each of the interframe predicted blocks into a code stream; if the interframe coded block exists at an adjacent position to the right or beneath or to the lower right of the intraframe coded block, performing intraframe prediction to the intraframe coded block based on at least one reconstructed coded blocks at adjacent positions to the left and/or above and/or to the upper left of the intraframe coded block and at least one of the interframe coded blocks at adjacent positions to the right and/or beneath and/or to the lower right of the intraframe coded block to obtain intraframe predicted blocks; writing information of each of the intraframe predicted blocks into the code stream.

### PRIORITY APPLICATION

This a Continuation-in-Part of application based on U.S. Ser. No. 16/478,607 filed Jul. 17, 2019, which claims priority to national stage filing under 35 U.S.C. § 371 of PCT/CN2017/095984, filed on Aug. 4, 2017, and Chinese Application No. 201710031017.7, filed on Jan. 17, 2017. The applications are incorporated herein by reference in their entirety.

### FIELD

Embodiments of the present disclosure generally relate to the field of computer technologies, and more particularly relate to an encoding method, a decoding method, an encoder, and a decoder.

### BACKGROUND

As people become increasingly demanding on resolutions, information transmission bandwidth and storage capacity occupied by videos also increase. How to improve video compression quality with a satisfactory video compression ratio is currently an urgent problem to solve.

In conventional coding methods, the processing sequence of a coding process is raster scan or Z scan, such that during performing intraframe prediction to an intraframe coded block, reference pixel points come from coded blocks already reconstructed to the left and/or above and/or to the upper left of the intraframe coded block.

However, because only the reconstructed coded blocks to the left and/or above and/or to the upper left of the intraframe coded block can be used for predicting the intraframe coded block, the prediction precision of the conventional coding methods needs to be further improved.

### SUMMARY

In view of the above, embodiments of the present disclosure provide an encoding method, a decoding method, an encoder, and a decoder, which may improve the prediction accuracy of intraframe prediction.

In a first aspect, an embodiment of the present disclosure provides an encoding method, comprising: performing interframe prediction to each interframe coded block in at least one coded block to obtain corresponding interframe predicted blocks; writing information of each of the interframe predicted blocks into a code stream; for each intraframe coded block in the at least one coded block, if the interframe coded block exists at an adjacent position to the right or beneath or to the lower right of the intraframe coded block, performing intraframe prediction to the intraframe coded block based on at least one reconstructed coded blocks at adjacent positions to the left and/or above and/or to the upper left of the intraframe coded block and at least one of the interframe coded blocks at adjacent positions to the right and/or beneath and/or to the lower right of the intraframe coded block to obtain intraframe predicted blocks; and writing information of each of the intraframe predicted blocks into the code stream.

In a second aspect, an embodiment of the present disclosure provides a decoding method, comprising: determining, based on information of at least one interframe predicted blocks in a code stream, an interframe coded block corresponding to each of the interframe predicted blocks; for information of each intraframe predicted block in the code stream, if the interframe coded block exists at an adjacent position to the right or beneath or to the lower right of the intraframe coded block corresponding to the intraframe predicted block, determining the intraframe predicted block based on the information of the intraframe predicted block, at least one reconstructed coded blocks at adjacent positions to the left and/or above and/or to the upper left of the intraframe coded block, and at least one of the interframe coded blocks at adjacent positions to the right and/or beneath and/or to the lower right of the intraframe coded block; and determining the intraframe coded block based on the intraframe predicted block.

In a third aspect, an embodiment of the present disclosure provides an encoder, comprising: an interframe predicting unit configured for performing interframe prediction to each interframe coded block in at least one coded block to obtain corresponding interframe predicted blocks; an intraframe predicting unit configured for: for each intraframe coded block in the at least one coded block, if the interframe coded block exists at an adjacent position to the right or beneath or to the lower right of the intraframe coded block, performing intraframe prediction to the intraframe coded block based on at least one reconstructed coded blocks at adjacent positions to the left and/or above and/or to the upper left of the intraframe coded block and at least one of the interframe coded blocks at adjacent positions to the right and/or beneath and/or to the lower right of the intraframe coded block to obtain intraframe predicted blocks; and a writing unit configured for writing information of each of the interframe predicted blocks into a code stream and writing information of each of the intraframe predicted blocks into the code stream.

In a fourth aspect, an embodiment of the present disclosure provides a decoder, comprising: an interframe decoding unit configured for determining, based on information of at least one interframe predicted blocks in a code stream, an interframe coded block corresponding to each of the interframe predicted blocks; and an intraframe decoding unit configured for: for information of each intraframe predicted block in the code stream, if the interframe coded block exists at an adjacent position to the right or beneath or to the lower right of the intraframe coded block corresponding to the intraframe predicted block, determining the intraframe predicted block based on the information of the intraframe predicted block, at least one reconstructed coded blocks at adjacent positions to the left and/or above and/or to the upper left of the intraframe coded block, and at least one of the interframe coded blocks at adjacent positions to the right and/or beneath and/or to the lower right of the intraframe coded block; and determining the intraframe coded block based on the intraframe predicted block.

At least one of the above technical solutions adopted by the embodiments of the present disclosure may achieve the following advantageous effects: the present encoding method changes the processing sequence of code units, wherein during the coding process, an interframe coded block is first subjected to interframe prediction, and then the information of the resulting interframe predicted block is written into a code stream. On this basis, if an interframe coded block exists at a position adjacent to the right or beneath or to the lower right of the intraframe coded block, because the interframe coded block has been completely coded, it may be used for performing intraframe prediction to the intraframe coded block. During the intraframe prediction process, the encoding method not only utilizes at least one reconstructed coded blocks at positions adjacent to the left and/or the above and/or to the upper left of the intraframe coded block as references, but also utilizes at least one interframe coded blocks at positions adjacent to the right and/or the beneath and/or to the lower right of the intraframe coded block as references, thereby being capable of improving the prediction precision of intraframe prediction.

### BRIEF DESCRIPTION OF THE DRAWINGS

To elucidate the technical solutions of the present disclosure or the prior art, the drawings used in describing the embodiments of the present disclosure or the prior art will be briefly introduced below. It is apparent that the drawings as described only relate to some embodiments of the present disclosure. To those skilled in the art, other drawings may be derived based on these drawings without exercise of inventive work, wherein:

FIG. 1 is a flow diagram of an encoding method provided according to an embodiment of the present disclosure;

FIG. 2 is a distribution diagram of intraframe coded blocks and interframe coded blocks according to an embodiment of the present disclosure;

FIG. 3 is a schematic diagram of a prediction direction in an HEVC according to an embodiment of the present disclosure;

FIG. 4 is a schematic diagram of a first time of intraframe prediction according to an embodiment of the present disclosure;

FIG. 5 is a schematic diagram of a second time of intraframe prediction according to an embodiment of the present disclosure;

FIG. 6 is a flow diagram of a decoding method provided according to an embodiment of the present disclosure;

FIG. 7 is a structural schematic diagram of an encoder according to an embodiment of the present disclosure; and

FIG. 8 is a structural schematic diagram of a decoder according to an embodiment of the present disclosure.

### DETAILED DESCRIPTION OF EMBODIMENTS

To make the objects, technical solutions, and advantages of the embodiments of the present disclosure much clearer, the technical solutions in the embodiments of the present disclosure will be described clearly and comprehensively with reference to the accompanying drawings of the embodiments of the present disclosure; apparently, the embodiments as described are only part of the embodiments of the present disclosure, rather than all of them. All other embodiments that may be contemplated by a person of normal skill in the art based on the embodiments in the present disclosure fall into the protection scope of the present disclosure.

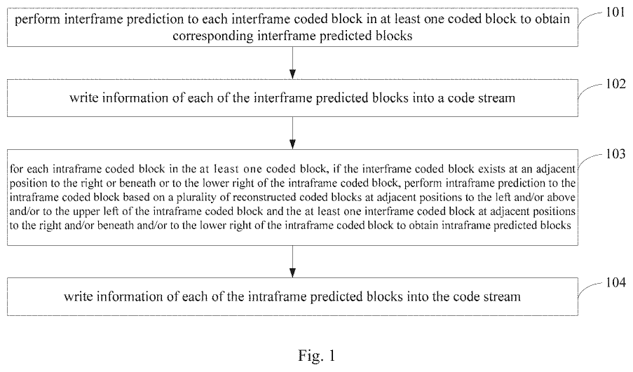

As shown in FIG. 1, an embodiment of the present disclosure provides an encoding method. The method may comprise the following steps:

Step 101: performing interframe prediction to each interframe coded block in at least one coded block to obtain corresponding interframe predicted blocks.

The encoding method is suitable for coding a coded block in an interframe picture, wherein the interframe picture may be a unidirectional predicted frame (P frame) or a bidirectional predicted frame (B frame).

In the step 101, various conventional interframe predicting methods may be adopted to perform interframe prediction to respective interframe coded blocks. The interframe prediction does not rely on other coded blocks in a spatial domain; instead, corresponding coded blocks are copied from the reference frame as the interframe predicted blocks.

Step 102: writing information of each of the interframe predicted blocks into a code stream.

The information of the interframe predicted block includes, but is not limited to, size, predictive mode, and reference picture of the interframe coded block.

Step 103: for each intraframe coded block in the at least one coded block, if the interframe coded block exists at an adjacent position to the right or beneath or to the lower right of the intraframe coded block, performing intraframe prediction to the intraframe coded block based on at least one reconstructed coded blocks at adjacent positions to the left and/or above and/or to the upper left of the intraframe coded block and at least one interframe coded blocks at adjacent positions to the right and/or beneath and/or to the lower right of the intraframe coded block to obtain intraframe predicted blocks.

Particularly, the reconstructed coded blocks may be reconstructed interframe coded blocks or reconstructed intraframe coded blocks.

Step 104: writing information of each of the intraframe predicted blocks into a code stream.

After each intraframe coded block is subjected to intraframe prediction, information of each of the intraframe predicted blocks is written into a code stream.

The present encoding method changes the processing sequence of code units, wherein during the coding process, an interframe coded block is first subjected to interframe prediction, and then the information of the resulting interframe predicted block is written into a code stream. On this basis, if an interframe coded block exists at a position adjacent to the right or beneath or to the lower right of the intraframe coded block, because the interframe coded block has been completely coded, it may be used for performing intraframe prediction to the intraframe coded block. During the intraframe prediction process, the encoding method not only utilizes at least one reconstructed coded blocks at positions adjacent to the left and/or the above and/or to the upper left of the intraframe coded block as references, but also utilizes at least one interframe coded blocks at positions adjacent to the right and/or the beneath and/or to the lower right of the intraframe coded block as references, thereby being capable of improving the prediction precision of intraframe prediction.

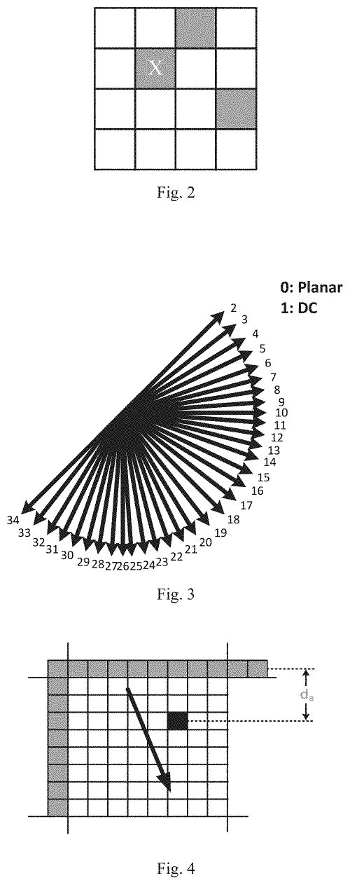

In an embodiment of the present disclosure, FIG. 2 shows a distribution diagram of intraframe coded blocks and interframe coded blocks, wherein gray blocks represent an intraframe coded block and white blocks represent interframe coded blocks. To the right, beneath, and to the lower right of block X are interframe coded blocks. Because these interframe coded blocks have been reconstructed before coding the block X, they may be utilized for performing intraframe prediction to the block X.

In an embodiment of the present disclosure, the step 103 comprises:

a1: performing a first time of intraframe prediction to the intraframe coded block based on the at least one reconstructed coded block at adjacent positions to the left and/or above and/or to the upper left of the intraframe coded block to obtain a first predicted block;

a1 may be implemented using a conventional intraframe predicting method.

a2: performing a second time of intraframe prediction to the intraframe coded block based on at least one interframe coded blocks at adjacent positions to the right and/or beneath and/or to the lower right of the intraframe coded block to obtain a second predicted block; and

a3: determining the intraframe predicted block based on the first predicted block and the second predicted block.

In an embodiment of the present disclosure, al may also be performed before the step 102.

In this case, the step 101 and a1 further have the following implementation manners: for each coded block in at least one coded block, performing interframe prediction to the coded block to obtain a corresponding interframe coded block; performing a first time of intraframe prediction to the coded block based on at least one reconstructed coded blocks at adjacent positions to the left and/or above and/or to the upper left of the coded block to obtain a corresponding first intraframe predicted block; determining whether the coded block adopts interframe prediction or intraframe prediction based on a preset decision algorithm, wherein in the case of adopting intraframe prediction, the coded block is an intraframe coded block, and in the case of adopting interframe prediction, the coded block is an interframe coded block.

In this embodiment, intraframe prediction may also be executed before interframe prediction. Namely, for each coded block in the at least one coded block, performing a first time of intraframe prediction to the coded block based on at least one reconstructed coded blocks at adjacent positions to the left and/or above and/or to the upper left of the coded block to obtain a corresponding first intraframe predicted block; and performing interframe prediction to the coded block to obtain a corresponding interframe coded block.

In an embodiment of the present disclosure, the intraframe predicted block is obtained by weighting the first predicted block and the second predicted block. In this case, the method further comprises: determining a prediction direction of the first time of intraframe prediction based on the intraframe coded block and the at least one reconstructed coded block at adjacent positions to the left and/or above and/or to the upper left of the intraframe coded block; determining a prediction direction of the second time of intraframe prediction based on the intraframe coded block and at least one of the interframe coded blocks at adjacent positions to the right and/or beneath and/or to the lower right of the intraframe coded block; determining a weight coefficient of the first predicted block based on the prediction direction of the first time of intraframe prediction; and determining a weight coefficient of the second predicted block based on the prediction direction of the second time of intraframe prediction.

In this case, a3 comprises: determining the intraframe predicted block based on the first predicted block and its weight coefficient, and the second predicted block and its weight coefficient.

In an embodiment of the present disclosure, a weight coefficient may be determined based on a prediction direction.

if the prediction direction of the first time of intraframe prediction is a vertical direction, it is determined that the weight coefficient of the first predicted block is a vertical distance between a predicted pixel point in the intraframe coded block and a reference pixel point in the at least one reconstructed coded block at adjacent positions to the left and/or above and/or to the upper left of the intraframe coded block.

if the prediction direction of the first time of intraframe prediction is a horizontal direction, it is determined that the weight coefficient of the first predicted block is a horizontal distance between a predicted pixel point in the intraframe coded block and a reference pixel point in the at least one reconstructed coded block at adjacent positions to the left and/or above and/or to the upper left of the intraframe coded block.

In an embodiment of the present disclosure, determining of the weight coefficient of the second predicted block is similar to determining of the weight coefficient of the first predicted block. Determining a weight coefficient of the second predicted block based on the prediction direction of the second time of intraframe prediction comprises: if the prediction direction of the second time of intraframe prediction is a vertical direction, determining that the weight coefficient of the second predicted block is a vertical distance between a predicted pixel point in the intraframe coded block and a reference pixel point in at least one of the interframe coded blocks at adjacent positions to the right and/or beneath and/or to the lower right of the intraframe coded block.

Determining a weight coefficient of the second predicted block based on the prediction direction of the second time of intraframe prediction comprises: if the prediction direction of the second time of intraframe prediction is a horizontal direction, determining that the weight coefficient of the second predicted block is a horizontal distance between a predicted pixel point in the intraframe coded block and a reference pixel point in at least one of the interframe coded blocks at adjacent positions to the right and/or beneath and/or to the lower right of the intraframe coded block.

In an embodiment of the present disclosure, a pixel value of the predicted pixel point in the intraframe predicted block may be determined based on equation (1) and equation (2) below:

$$\begin{matrix}{P}_{comb} ( x , y ) = ( {d}_{b} \cdot {P}_{a} ( x , y ) + {d}_{a} \cdot {P}_{b} ( x , y ) + ( 1 \text{?} ( shift - 1 ) ) ) \text{?} shift & ( 1 ) \\ shift = {log}_{2} ( {d}_{a} + {d}_{b} ) \\ \text{?} \text{indicates text missing or illegible when filed} & ( 2 )\end{matrix}$$

where P_{comb} denotes the pixel value of the predicted pixel point in the intraframe predicted block; Pₐ denotes the pixel value of the predicted pixel point in the first predicted block; P_{b} denotes the pixel value of the predicted pixel point in the second predicted block; x, y denote coordinates of the predicted pixel point, respectively; dₐ denotes the weight coefficient of the first predicted block; d_{b} denotes the weight coefficient of the second predicted block; shift is a normalized parameter for controlling the P_{comb} within a prescribed scope.

As shown in FIG. 3, 2-17 denotes that the prediction direction is a horizontal direction, and 18-34 denotes that the prediction direction is a vertical direction.

As shown in FIG. 4, the black blocks represent predicted pixel points, while the gray blocks represent reference pixel points. It may be seen from FIG. 4 that if the prediction direction of the first time of intraframe prediction is a vertical direction, it is determined that the weight coefficient of the first predicted block is a vertical distance dₐ between a predicted pixel point in the intraframe coded block and a reference pixel point in the at least one reconstructed coded block at adjacent positions to the left and/or above and/or to the upper left of the intraframe coded block.

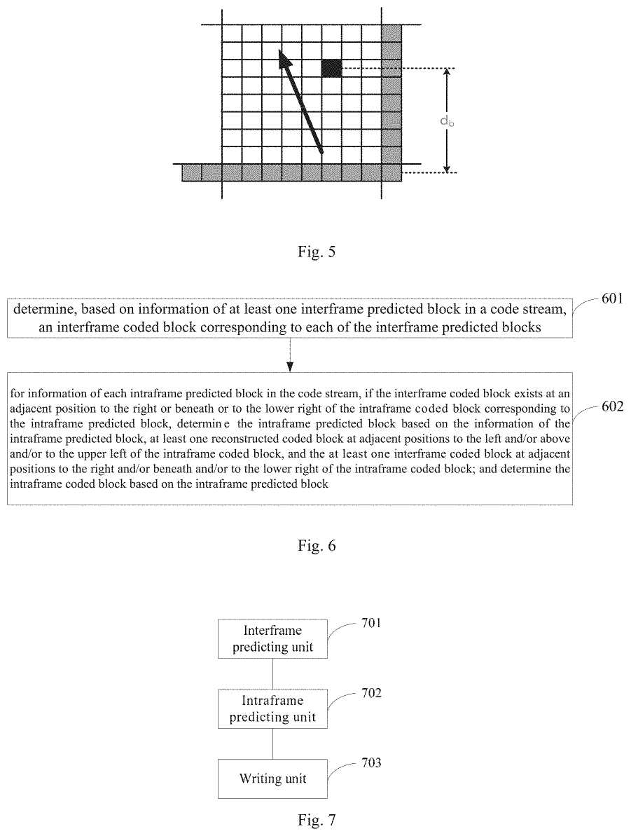

As shown in FIG. 5, the black blocks represent predicted pixel points, while the gray blocks represent reference pixel points. It may be seen from FIG. 5 that if the prediction direction of the second time of intraframe prediction is a vertical direction, determining that the weight coefficient of the second predicted block is a vertical distance d_{b} between a predicted pixel point in the intraframe coded block and a reference pixel point in at least one of the interframe coded blocks at adjacent positions to the right and/or beneath and/or to the lower right of the intraframe coded block.

In an embodiment of the present disclosure, the method further comprises: determining, based on a preset decision algorithm, whether to utilize at least one interframe coded blocks at adjacent positions to the right and/or beneath and/or to the lower right of the intraframe coded block to perform intraframe prediction; if so, executing a step of: performing intraframe prediction to the intraframe coded block based on at least one reconstructed coded blocks at adjacent positions to the left and/or above and/or to the upper left of the intraframe coded block and at least one interframe coded blocks at adjacent positions to the right and/or beneath and/or to the lower right of the intraframe coded block.

With a decision algorithm, it may be determined whether at least one interframe coded blocks at adjacent positions to the right and/or beneath and/or to the lower right of the intraframe coded block are adopted during the process of intraframe prediction, thereby improving coding quality while guaranteeing the coding efficiency. Particularly, the decision algorithm includes, but is not limited to, RDO (Rate Distortion Optimized) and RMD (Rough Mode Decision).

If the coding utilizes at least one interframe coded blocks at adjacent positions to the right and/or beneath or to the lower right of the intraframe coded block, to facilitate a decoding process, a coding identifier may be added to the information of the intraframe prediction block, wherein the coding identifier is for identifying whether at least one interframe coded blocks at adjacent positions to the right or beneath or to the lower right of the intraframe coded block are utilized during the process of intraframe prediction. For example, when a value of the coding identifier is set to 1, it indicates that at least one of the interframe coded blocks at adjacent positions to the right or beneath or to the lower right of the intraframe coded block are utilized during the process of intraframe prediction. In an actual application scenario, the set value may be 1-bit.

As shown in FIG. 6, an embodiment of the present disclosure provides a decoding method, comprising:

Step 601: determining, based on information of at least one interframe predicted blocks in a code stream, an interframe coded block corresponding to each of the interframe predicted blocks.

Step 602: for information of each intraframe predicted block in the code stream, if the interframe coded block exists at an adjacent position to the right or beneath or to the lower right of the intraframe coded block corresponding to the intraframe predicted block, determining the intraframe predicted block based on the information of the intraframe predicted block, at least one reconstructed coded blocks at adjacent positions to the left and/or above and/or to the upper left of the intraframe coded block, and at least one interframe coded blocks at adjacent positions to the right and/or beneath and/or to the lower right of the intraframe coded block; and determining the intraframe coded block based on the intraframe predicted block.

Corresponding to the encoding method, the decoding method changes the decoding sequence of code units in the conventional decoding methods, wherein during the decoding process, the present decoding method first performs decoding to obtain an interframe coded block and then performs decoding based on the decoded interframe coded block to obtain the intraframe coded block. During the intraframe prediction process, the decoding method not only utilizes at least one reconstructed coded blocks at positions adjacent to the left and/or the above and/or to the upper left of the intraframe coded block as references, but also utilizes at least one interframe coded blocks at positions adjacent to the right and/or the beneath and/or to the lower right of the intraframe coded block as references, thereby being capable of improving the prediction precision of intraframe prediction.

As the decoding process is reverse to the encoding process, the above illustrations on the interframe prediction and the intraframe prediction are likewise applicable to the decoding process below.

In an embodiment of the present disclosure, determining the intraframe predicted block based on the information of the intraframe predicted block, the at least one reconstructed coded block at adjacent positions to the left and/or above and/or to the upper left of the intraframe coded block, and at least one interframe coded blocks at adjacent positions to the right and/or beneath and/or to the lower right of the intraframe coded block comprises: performing a first time of intraframe prediction to the intraframe coded block based on the information of the intraframe predicted block and the at least one reconstructed coded block at adjacent positions to the left and/or above and/or to the upper left of the intraframe coded block to obtain a first predicted block; performing a second time of intraframe prediction to the intraframe coded block based on the information of the intraframe predicted block and at least one of the interframe coded blocks at adjacent positions to the right and/or beneath and/or to the lower right of the intraframe coded block to obtain a second predicted block; and determining the intraframe predicted block based on the first predicted block and the second predicted block.

In an embodiment of the present disclosure, the decoding method further comprises: determining a prediction direction of the first time of intraframe prediction based on the information of the intraframe predicted block, the at least one reconstructed coded block at adjacent positions to the left and/or above and/or to the upper left of the intraframe coded block, and the intraframe coded block; determining a prediction direction of the second time of intraframe prediction based on the information of the intraframe predicted block, at least one of the interframe coded blocks at adjacent positions to the right and/or beneath and/or to the lower right of the intraframe coded block, and the intraframe coded block; determining a weight coefficient of the first predicted block based on the prediction direction of the first time of intraframe prediction; determining a weight coefficient of the second predicted block based on the prediction direction of the second time of intraframe prediction; and the determining the intraframe predicted block based on the first predicted block and the second predicted block comprises: determining the intraframe predicted block based on the first predicted block and its weight coefficient, and the second predicted block and its weight coefficient.

In an embodiment of the present disclosure, the determining a weight coefficient of the first predicted block based on the prediction direction of the first time of intraframe prediction comprises: if the prediction direction of the first time of intraframe prediction is a vertical direction, determining that the weight coefficient of the first predicted block is a vertical distance between a predicted pixel point in the intraframe coded block and a reference pixel point in the at least one reconstructed coded block at adjacent positions to the left and/or above and/or to the upper left of the intraframe coded block.

In an embodiment of the present disclosure, the determining a weight coefficient of the first predicted block based on the prediction direction of the first time of intraframe prediction comprises: if the prediction direction of the first time of intraframe prediction is a horizontal direction, determining that the weight coefficient of the first predicted block is a horizontal distance between a predicted pixel point in the intraframe coded block and a reference pixel point in the at least one reconstructed coded block at adjacent positions to the left and/or above and/or to the upper left of the intraframe coded block.

In an embodiment of the present disclosure, determining of the weight coefficient of the second predicted block is similar to determining of the weight coefficient of the first predicted block. Determining a weight coefficient of the second predicted block based on the prediction direction of the second time of intraframe prediction comprises: if the prediction direction of the second time of intraframe prediction is a vertical direction, determining that the weight coefficient of the second predicted block is a vertical distance between a predicted pixel point in the intraframe coded block and a reference pixel point in the at least one reconstructed coded block at adjacent positions to the right and/or beneath and/or to the lower right of the intraframe coded block.

Determining a weight coefficient of the second predicted block based on the prediction direction of the second time of intraframe prediction comprises: if the prediction direction of the second time of intraframe prediction is a horizontal direction, determining that the weight coefficient of the second predicted block is a horizontal distance between a predicted pixel point in the intraframe coded block and a reference pixel point in at least one of the interframe coded blocks at adjacent positions to the right and/or beneath and/or to the lower right of the intraframe coded block.

In an embodiment of the present disclosure, the decoding method further comprises: determining whether a value of a coding identifier in the information of the intraframe predicted block is a set value; if yes, executing the step of: determining the intraframe predicted block based on the information of the intraframe predicted block, the at least one reconstructed coded block at adjacent positions to the left and/or above and/or to the upper left of the intraframe coded block, and at least one of the interframe coded blocks at adjacent positions to the right and/or beneath and/or to the lower right of the intraframe coded block; wherein the set value is configured for identifying that the intraframe prediction process utilizes at least one interframe coded blocks at adjacent positions to the right and/or beneath and/or to the lower right of the intraframe coded block.

As shown in FIG. 7, an embodiment of the present disclosure provides an encoder, comprising: an interframe predicting unit 701 configured for performing interframe prediction to each interframe coded block in at least one coded block to obtain corresponding interframe predicted blocks; an intraframe predicting unit 702 configured for: for each intraframe coded block in the at least one coded block, if the interframe coded block exists at an adjacent position to the right or beneath or to the lower right of the intraframe coded block, performing intraframe prediction to the intraframe coded block based on at least one reconstructed coded blocks at adjacent positions to the left and/or above and/or to the upper left of the intraframe coded block and at least one interframe coded blocks at adjacent positions to the right and/or beneath and/or to the lower right of the intraframe coded block to obtain intraframe predicted blocks; and a writing unit 703 configured for writing information of each of the interframe predicted blocks into a code stream and writing information of respective intraframe prediction blocks into the code stream.

In an embodiment of the present disclosure, the intraframe predicting unit 702 is configured for: performing a first time of intraframe prediction to the intraframe coded block based on the at least one reconstructed coded block at adjacent positions to the left and/or above and/or to the upper left of the intraframe coded block to obtain a first predicted block; performing a second time of intraframe prediction to the intraframe coded block based on at least one of the interframe coded blocks at adjacent positions to the right and/or beneath and/or to the lower right of the intraframe coded block to obtain a second predicted block; and determining the intraframe predicted block based on the first predicted block and the second predicted block.

In an embodiment of the present disclosure, the intraframe predicting unit 702 is further configured for: determining a prediction direction of the first time of intraframe prediction based on the intraframe coded block and the at least one reconstructed coded block at adjacent positions to the left and/or above and/or to the upper left of the intraframe coded block; determining a prediction direction of the second time of intraframe prediction based on the intraframe coded block and at least one of the interframe coded blocks at adjacent positions to the right and/or beneath and/or to the lower right of the intraframe coded block; determining a weight coefficient of the first predicted block based on the prediction direction of the first time of intraframe prediction; and determining a weight coefficient of the second predicted block based on the prediction direction of the second time of intraframe prediction; the intraframe predicting unit 702 is configured for determining the intraframe predicted block based on the first predicted block and its weight coefficient, and the second predicted block and its weight coefficient.

In an embodiment of the present disclosure, the intraframe predicting unit 702 is configured for: if the prediction direction of the first time of intraframe prediction is a vertical direction, determining that the weight coefficient of the first predicted block is a vertical distance between a predicted pixel point in the intraframe coded block and a reference pixel point in the at least one reconstructed coded block at adjacent positions to the left and/or above and/or to the upper left of the intraframe coded block.

In an embodiment of the present disclosure, the intraframe predicting unit 702 is configured for: if the prediction direction of the first time of intraframe prediction is a horizontal direction, determining that the weight coefficient of the first predicted block is a horizontal distance between a predicted pixel point in the reconstructed coded block and a reference pixel point in the at least one reconstructed coded block at adjacent positions to the left and/or above and/or to the upper left of the intraframe coded block.

In an embodiment of the present disclosure, the information of the intraframe predicted block includes: a coding identifier; a value of the coding identifier is a set value; wherein the set value is configured for identifying that the intraframe prediction process utilizes at least one of the interframe coded blocks at adjacent positions to the right and/or beneath and/or to the lower right of the intraframe coded block.

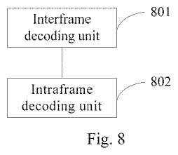

As shown in FIG. 8, an embodiment of the present disclosure provides a decoder, comprising: an interframe decoding unit 801 configured for determining, based on information of at least one interframe predicted blocks in a code stream, an interframe coded block corresponding to each of the interframe predicted blocks; and an intraframe decoding unit 802 configured for: for information of each intraframe predicted block in the code stream, if the interframe coded block exists at an adjacent position to the right or beneath or to the lower right of the intraframe coded block corresponding to the intraframe predicted block, determining the intraframe coded block based on the information of the intraframe predicted block, at least one reconstructed coded blocks at adjacent positions to the left and/or above and/or to the upper left of the intraframe coded block, and at least one interframe coded blocks at adjacent positions to the right and/or beneath and/or to the lower right of the intraframe coded block; and determining the intraframe coded block based on the intraframe predicted block.

In an embodiment of the present disclosure, the intraframe decoding unit 802 is configured for performing a first time of intraframe prediction to the intraframe coded block based on the information of the intraframe predicted block and the at least one reconstructed coded block at adjacent positions to the left and/or above and/or to the upper left of the intraframe coded block to obtain a first predicted block; performing a second time of intraframe prediction to the intraframe coded block based on the information of the intraframe predicted block and at least one interframe coded blocks at adjacent positions to the right and/or beneath and/or to the lower right of the intraframe coded block to obtain a second predicted block; and determining the intraframe predicted block based on the first predicted block and the second predicted block.

In an embodiment of the present disclosure, the intraframe decoding unit 802 is further configured for: determining a prediction direction of the first time of intraframe prediction based on the information of the intraframe predicted block, the at least one reconstructed coded block at adjacent positions to the left and/or above and/or to the upper left of the intraframe coded block, and the intraframe coded block; determining a prediction direction of the second time of intraframe prediction based on the information of the intraframe predicted block, at least one of the interframe coded blocks at adjacent positions to the right and/or beneath and/or to the lower right of the intraframe coded block, and the intraframe coded block; determining a weight coefficient of the first predicted block based on the prediction direction of the first time of intraframe prediction; and determining a weight coefficient of the second predicted block based on the prediction direction of the second time of intraframe prediction; the intraframe decoding unit 802 is configured for determining the intraframe predicted block based on the first predicted block and its weight coefficient, and the second predicted block and its weight coefficient.

In an embodiment of the present disclosure, the intraframe decoding unit 802 is configured for: if the prediction direction of the first time of intraframe prediction is a vertical direction, determining that the weight coefficient of the first predicted block is a vertical distance between a predicted pixel point in the intraframe coded block and a reference pixel point in the at least one reconstructed coded block at adjacent positions to the left and/or above and/or to the upper left of the intraframe coded block.

In an embodiment of the present disclosure, the intraframe decoding unit 802 is configured for: if the prediction direction of the first time of intraframe prediction is a horizontal direction, determining that the weight coefficient of the first predicted block is a horizontal distance between a predicted pixel point in the intraframe coded block and a reference pixel point in the at least one reconstructed coded block at adjacent positions to the left and/or above and/or to the upper left of the intraframe coded block.

In an embodiment of the present disclosure, the intraframe decoding unit 802 is further configured for determining whether a value of a coding identifier in the information of the intraframe predicted block is a set value; if yes, executing a step of: determining the intraframe coded block based on the information of the intraframe predicted block, at least one reconstructed coded blocks at adjacent positions to the left and/or above and/or to the upper left of the intraframe coded block, and at least one interframe coded blocks at adjacent positions to the right and/or beneath and/or to the lower right of the intraframe coded block; wherein the set value is configured for identifying that an intraframe prediction process utilizes at least one of the interframe coded blocks at adjacent positions to the right and/or beneath and/or to the lower right of the intraframe coded block.

In 1990s, improvement of a technology may be apparently differentiated into hardware improvement (e.g., improvement of a circuit structure such as a diode, a transistor, a switch, etc.) or software improvement (e.g., improvement of a method process). However, with development of technology, currently, improvement of many method processes may be regarded as direct improvement to a hardware circuit structure. Designers always program an improved method process into a hardware circuit to obtain a corresponding hardware circuit structure. Therefore, it is improper to allege that improvement of a method process cannot be implemented by a hardware entity module. For example, a programmable logic device (PLD) (such as a field programmable gate array FPGA) is such an integrated circuit, a logic function of which is determined by programming a corresponding device. A designer may integrate a digital system on a piece of PLD by programming, without a need of engaging a chip manufacturer to design and fabricate a dedicated integrated circuit chip. Moreover, currently, in replacement of manual fabrication of an integrated circuit chip, this programming is mostly implemented by a logic compiler, which is similar to a software compiler used when developing and writing a program. To compile the previous original code, a specific programming language is needed, which is referred to as a hardware description language (HDL). Further, there are more than one HDLs, e.g., ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), among which, VHDL (Very-High-Speed Integrated Circuit Hardware Description Language) and Verilog are used most prevalently. Those skilled in the art should also understand that a hardware circuit for a logic method process can be easily implemented by subjecting, without much efforts, the method process to logic programming using the above hardware descriptive languages into an integrated circuit.

A controller may be implemented according to any appropriate manner. For example, the controller may adopt manners such as a microprocessor or processor and a computer readable medium storing computer readable program codes (e.g., software or firmware) executible by the (micro) processor, a logic gate, a switch, an application specific integrated circuit (ASIC), a programmable logic controller, and an inlaid microcontroller. Examples of the controller include, but are not limited to, the following microcontrollers: ARC 625D, Atmel AT91SAM, Microchip PIC18F26K20 and Silicone Labs C8051F320. The memory controller may also be implemented as part of the control logic of the memory. Those skilled in the art may further understand that besides implementing the controller by pure computer readable program codes, the method steps may be surely subjected to logic programming to enable the controller to implement the same functions in forms of a logic gate, a switch, an ASIC, a programmable logic controller, and an inlaid microcontroller, etc. Therefore, the controller may be regarded as a hardware component, while the modules for implementing various functions included therein may also be regarded as the structures inside the hardware component. Or, the modules for implementing various functions may be regarded as software modules for implementing the method or structures inside the hardware component.

The system, apparatus, module or unit illustrated by the embodiments above may be implemented by a computer chip or entity, or implemented by a product having a certain function. A typical implementation device is a computer. Specifically, the computer for example may be a personal computer, a laptop computer, a cellular phone, a camera phone, a smart phone, a personal digital assistant, a media player, a navigation device, an email device, a game console, a tablet computer, a wearable device, or a combination of any of these devices.

To facilitate description, the apparatuses above are partitioned into various units by functions to describe. Of course, when implementing the present application, functions of various units may be implemented in one or more pieces of software and/or hardware.

Those skilled in the art should understand that the embodiments of the present disclosure may be provided as a method, a system, or a computer program product. Therefore, the present disclosure may adopt a form of complete hardware embodiment, a complete software embodiment, or an embodiment combining software and hardware. Moreover, the present disclosure may adopt a form of a computer program product implemented on one or more computer-adaptable storage media including computer-adaptable program code (including, but not limited to, a magnetic disc memory, CD-ROM, and optical memory, etc.).

The present disclosure is described with reference to the flow diagram and/or block diagram of the method, apparatus (system) and computer program product according to the embodiments of the present disclosure. It should be understood that each flow and/or block in the flow diagram and/or block diagram, and a combination of the flow and/or block in the flow diagram and/or block diagram, may be implemented by computer program instructions. These computer program instructions may be provided to a processor of a general-purpose computer, a dedicated computer, an embedded processor, or other programmable data processing device to generate a machine, such that an apparatus for implementing the functions specified in one or more flows of the flow diagram and/or one or more blocks in the block diagram is implemented via the computer or the processor of other programmable data processing device.

These computer program instructions may also be stored in a computer readable memory that may boot the computer or other programmable data processing device to work in a specific manner such that the instructions stored in the computer readable memory to produce a product including an instruction apparatus, the instruction apparatus implementing the functions specified in one or more flows of the flow diagram and/or in one or more blocks in the block diagram.

These computer program instructions may be loaded on the computer or other programmable data processing device, such that a series of operation steps are executed on the computer or other programmable device to generate a processing implemented by the computer, such that the instructions executed on the computer or other programmable device provide steps for implementing the functions specified in one or more flows of the flow diagram and/or one or more blocks in the block diagram is implemented via the computer or the processor of other programmable data processing device.

In a typical configuration, the computing device includes one or more processors (CPUs), an input/output interface, a network interface, and a memory.

The memory may include a non-permanent memory in a computer readable medium, a random access memory (RAM) and/or a non-volatile memory, e.g., a read-only memory

(ROM) or a flash memory (flash RAM). The memory is an example of a computer readable medium.

The computer readable memory includes a permanent type, non-permanent type, a mobile type, and a non-mobile type, which may implement information storage by any method or technology. The information may be a computer-readable instruction, a data structure, a module of a program or other data. Examples of the memory mediums of the computer include, but are not limited to, a phase-change RAM (PRAM), a static random access memory (SRAM), a dynamic random access memory (DRAM), other type of random access memory (RAM), a read-only memory (ROM), an electrically erasable programmable read only memory (EEPROM), a flash memory body or other memory technology, a CD-ROM (Compact Disc Read - Only Memory), a digital multi-function optical disc (DVD) or other optical memory, a magnetic cassette type magnetic tape, a magnetic tape disc memory, or other magnetic storage device or any other non-transmission medium which may be configured for storing information to be accessed by a computing device. Based on the definitions in the specification, the computer readable medium does not include a transitory media, e.g., a modulated data signal and a carrier.

It needs also be noted that the terms “include,” “comprise” or any other variables intend for a non-exclusive inclusion, such that a process, a method, a product or a system including a series of elements not only includes those elements, but also includes other elements that are not explicitly specified or further includes the elements inherent in the process, method, product or system. Without more restrictions, an element limited by the phase “including one . . . ” does not exclude a presence of further equivalent elements in the process, method, product or system including the elements.

The present application may be described in a general context of the computer-executable instruction executed by the computer, for example, a program module. Generally, the program module includes a routine, a program, an object, a component, and a data structure, etc., which executes a specific task or implements a specific abstract data type.

The present application may be practiced in a distributed computing environment, in which a task is performed by a remote processing device connected via a communication network. In the distributed computing environment, the program module may be located on a local or remote computer storage medium, including the memory device.

Respective embodiments in the specification are described in a progressive manner, and same or similar parts between various embodiments may be referenced to each other, while each embodiment focuses on differences from other embodiments. Particularly, for a system embodiment, because it is substantially similar to the method embodiment, it is described relatively simply. Relevant parts may refer to the method embodiments.

What have been described above are only preferred embodiments of the present disclosure, not for limiting the present disclosure; to those skilled in the art, the present disclosure may have various alterations and changes. Any modifications, equivalent substitutions, and improvements within the spirit and principle of the present disclosure should be included within the protection scope of the present disclosure.

I/we claim:

1. An encoding method, comprising:
performing interframe prediction to each interframe coded block in at least one coded block to obtain corresponding interframe predicted blocks;
writing information of each of the interframe predicted blocks into a code stream;
for each intraframe coded block in the at least one coded block, if the interframe coded block exists at an adjacent position to the right or beneath or to the lower right of the intraframe coded block, performing intraframe prediction to the intraframe coded block based on at least one reconstructed coded blocks at adjacent positions to the left and/or above and/or to the upper left of the intraframe coded block and at least one of the interframe coded blocks at adjacent positions to the right and/or beneath and/or to the lower right of the intraframe coded block to obtain intraframe predicted blocks; and
writing information of each of the intraframe predicted blocks into the code stream.

2. The coding method according to claim 1, wherein:
the performing intraframe prediction to the intraframe coding block based on at least one reconstructed coding blocks at adjacent positions to a left and/or above and/or to the upper left of the intraframe coding block and at least one of the interframe coding blocks at adjacent positions to a right and/or beneath and/or to the lower right of the intraframe coding block to obtain intraframe predicted blocks comprises:
performing a first time of intraframe prediction to the intraframe coded block based on the at least one reconstructed coded block at adjacent positions to the left and/or above and/or to the upper left of the intraframe coded block to obtain a first predicted block;
performing a second time of intraframe prediction to the intraframe coded block based on at least one interframe coded blocks at adjacent positions to the right and/or beneath and/or to the lower right of the intraframe coded block to obtain a second predicted block; and
determining the intraframe predicted block based on the first predicted block and the second predicted block.

3. The encoding method according to claim 2, further comprising:
determining a prediction direction of the first time of intraframe prediction based on the intraframe coded block and the at least one reconstructed coded block at adjacent positions to the left and/or above and/or to the upper left of the intraframe coded block;
determining a prediction direction of the second time of intraframe prediction based on the intraframe coded block and at least one of the interframe coded blocks at adjacent positions to the right and/or beneath and/or to the lower right of the intraframe coded block;
determining a weight coefficient of the first predicted block based on the prediction direction of the first time of intraframe prediction; and
determining a weight coefficient of the second predicted block based on the prediction direction of the second time of intraframe prediction;
wherein the determining the intraframe predicted block based on the first predicted block and the second predicted block comprises:
determining the intraframe predicted block based on the first predicted block and its weight coefficient, and the second predicted block and its weight coefficient.

4. The encoding method according to claim 3, wherein the determining a weight coefficient of the second predicted block based on the prediction direction of the second time of intraframe prediction comprises:
if the prediction direction of the second time of intraframe prediction is a vertical direction, determining that the weight coefficient of the second predicted block is a vertical distance between a predicted pixel point in the intraframe coded block and a reference pixel point in at least one of the interframe coded blocks at adjacent positions to the right and/or beneath and/or to the lower right of the intraframe coded block.

5. The encoding method according to claim 3, wherein
the determining a weight coefficient of the second predicted block based on the prediction direction of the second time of intraframe prediction comprises:
if the prediction direction of the second time of intraframe prediction is a horizontal direction, determining that the weight coefficient of the second predicted block is a horizontal distance between a predicted pixel point in the intraframe coded block and a reference pixel point in at least one of the interframe coded blocks at adjacent positions to the right and/or beneath and/or to the lower right of the intraframe coded block

6. The encoding method according to claim 1, wherein
the information of the intraframe predicted block includes: a coding identifier;
a value of the coding identifier is a set value;
wherein the set value is configured for identifying that an intraframe prediction process utilizes at least one of the interframe coded blocks at adjacent positions to the right and/or beneath and/or to the lower right of the intraframe coded block.

7. The encoding method according to claim 1, further comprising:
determining, based on a preset decision algorithm, whether to utilize at least one of the interframe coded blocks at adjacent positions to the right and/or beneath and/or to the lower right of the intraframe coded block to perform intraframe prediction; if so, executing a step of:
performing intraframe prediction to the intraframe coded block based on at least one reconstructed coded blocks at adjacent positions to the left and/or above and/or to the upper left of the intraframe coded block and at least one of the interframe coded blocks at adjacent positions to the right and/or beneath and/or to the lower right of the intraframe coded block

8. A decoding method, comprising:
determining, based on information of at least one interframe predicted blocks in a code stream, an interframe coded block corresponding to each of the interframe predicted blocks;
for information of each intraframe predicted block in the code stream, if the interframe coded block exists at an adjacent position to the right or beneath or to the lower right of the intraframe coded block corresponding to the intraframe predicted block, determining the intraframe predicted block based on the information of the intraframe predicted block, at least one reconstructed coded blocks at adjacent positions to the left and/or above and/or to the upper left of the intraframe coded block, and at least one of the interframe coded blocks at adjacent positions to the right and/or beneath and/or to the lower right of the intraframe coded block; and determining the intraframe coded block based on the intraframe predicted block.

9. The decoding method according to claim 8, wherein determining the intraframe predicted block based on the information of the intraframe predicted block, the at least one reconstructed coded block at adjacent positions to the left and/or above and/or to the upper left of the intraframe coded block, and at least one of the interframe coded blocks at adjacent positions to the right and/or beneath and/or to the lower right of the intraframe coded block comprises:
performing a first time of intraframe prediction to the intraframe coded block based on the information of the intraframe predicted block and the at least one reconstructed coded block at adjacent positions to the left and/or above and/or to the upper left of the intraframe coded block to obtain a first predicted block;
performing a second time of intraframe prediction to the intraframe coded block based on the information of the intraframe predicted block and at least one of the interframe coded blocks at adjacent positions to the right and/or beneath and/or to the lower right of the intraframe coded block to obtain a second predicted block; and
determining the intraframe predicted block based on the first predicted block and the second predicted block.

10. The decoding method according to claim 8, further comprising:
determining a prediction direction of the first time of intraframe prediction based on the information of the intraframe predicted block, the at least one reconstructed coded block at adjacent positions to the left and/or above and/or to the upper left of the intraframe coded block, and the intraframe coded block;
determining a prediction direction of the second time of intraframe prediction based on the information of the intraframe predicted block, at least one of the interframe coded blocks at adjacent positions to the right and/or beneath and/or to the lower right of the intraframe coded block, and the intraframe coded block;
determining a weight coefficient of the first predicted block based on the prediction direction of the first time of intraframe prediction;
determining a weight coefficient of the second predicted block based on the prediction direction of the second time of intraframe prediction; and wherein
the determining the intraframe predicted block based on the first predicted block and the second predicted block comprises:
determining the intraframe predicted block based on the first predicted block and its weight coefficient, and the second predicted block and its weight coefficient.

11. The decoding method according to claim 10, wherein
the determining a weight coefficient of the second predicted block based on the prediction direction of the second time of intraframe prediction comprises: if the prediction direction of the second time of intraframe prediction is a vertical direction, determining that the weight coefficient of the second predicted block is a vertical distance between a predicted pixel point in the intraframe coded block and a reference pixel point in at least one of the interframe coded blocks at adjacent positions to the right and/or beneath and/or to the lower right of the intraframe coded block.

12. The decoding method according to claim 10, wherein
the determining a weight coefficient of the second predicted block based on the prediction direction of the second time of intraframe prediction comprises: if the prediction direction of the second time of intraframe prediction is a horizontal direction, determining that the weight coefficient of the second predicted block is a horizontal distance between a predicted pixel point in the intraframe coded block and a reference pixel point in at least one of the interframe coded blocks at adjacent positions to the right and/or beneath and/or to the lower right of the intraframe coded block.

13. The decoding method according to claim 1, further comprising:
determining whether a value of a coding identifier in the information of the intraframe predicted block is a set value; if yes, executing a step of: determining the intraframe predicted block based on the information of the intraframe predicted block, the at least one reconstructed coded block at adjacent positions to the left and/or above and/or to the upper left of the intraframe coded block, and at least one of the interframe coded blocks at adjacent positions to the right and/or beneath and/or to the lower right of the intraframe coded block;
wherein the set value is configured for identifying that an intraframe prediction process utilizes at least one of the interframe coded blocks at adjacent positions to the right and/or beneath and/or to the lower right of the intraframe coded block.

14. An encoder, comprising:
an interframe predicting unit configured for performing interframe prediction to each interframe coded block in at least one coded block to obtain corresponding interframe predicted blocks;
an intraframe predicting unit configured for: for each intraframe coded block in the at least one coded block, if the interframe coded block exists at an adjacent position to the right or beneath or to the lower right of the intraframe coded block, performing intraframe prediction to the intraframe coded block based on at least one reconstructed coded blocks at adjacent positions to the left and/or above and/or to the upper left of the intraframe coded block and at least one of the interframe coded blocks at adjacent positions to the right and/or beneath and/or to the lower right of the intraframe coded block to obtain intraframe predicted blocks; and
a writing unit configured for writing information of each of the interframe predicted blocks into a code stream and writing information of each of the intraframe predicted blocks into the code stream.

15. The encoder according to claim 14, wherein
the intraframe predicting unit is configured for: performing a first time of intraframe prediction to the intraframe coded block based on the at least one reconstructed coded block at adjacent positions to the left and/or above and/or to the upper left of the intraframe coded block to obtain a first predicted block; performing a second time of intraframe prediction to the intraframe coded block based on at least one of the interframe coded blocks at adjacent positions to the right and/or beneath and/or to the lower right of the intraframe coded block to obtain a second predicted block; and determining the intraframe predicted block based on the first predicted block and the second predicted block.

16. The encoder according to claim 15, wherein
the intraframe predicting unit is further configured for: determining a prediction direction of the first time of intraframe prediction based on the intraframe coded block and the at least one reconstructed coded block at adjacent positions to the left and/or above and/or to the upper left of the intraframe coded block; determining a prediction direction of the second time of intraframe prediction based on the intraframe coded block and at least one of the interframe coded blocks at adjacent positions to the right and/or beneath and/or to the lower right of the intraframe coded block; determining a weight coefficient of the first predicted block based on the prediction direction of the first time of intraframe prediction; and determining a weight coefficient of the second predicted block based on the prediction direction of the second time of intraframe prediction; and
the intraframe predicting unit is configured for determining the intraframe predicted block based on the first predicted block and its weight coefficient, and the second predicted block and its weight coefficient.

17. A decoder, comprising:
an interframe decoding unit configured for determining, based on information of at least one interframe predicted blocks in a code stream, an interframe coded block corresponding to each of the interframe predicted blocks; and
an intraframe decoding unit configured for: for information of each intraframe predicted block in the code stream, if the interframe coded block exists at an adjacent position to the right or beneath or to the lower right of the intraframe coded block corresponding to the intraframe predicted block, determining the intraframe predicted block based on the information of the intraframe predicted block, at least one reconstructed coded blocks at adjacent positions to the left and/or above and/or to the upper left of the intraframe coded block, and at least one of the interframe coded blocks at adjacent positions to the right and/or beneath and/or to the lower right of the intraframe coded block; and determining the intraframe coded block based on the intraframe predicted block.

18. The decoder according to claim 17, wherein:
the intraframe decoding unit is configured for performing a first time of intraframe prediction to the intraframe coded block based on the information of the intraframe predicted block and the at least one reconstructed coded block at adjacent positions to the left and/or above and/or to the upper left of the intraframe coded block to obtain a first predicted block;
performing a second time of intraframe prediction to the intraframe coded block based on the information of the intraframe predicted block and at least one interframe coded blocks at adjacent positions to the right and/or beneath and/or to the lower right of the intraframe coded block to obtain a second predicted block; and determining the intraframe predicted block based on the first predicted block and the second predicted block.

19. The decoder according to claim 17, wherein
the intraframe decoding unit is further configured for: determining a prediction direction of the first time of intraframe prediction based on the information of the intraframe predicted block, the at least one reconstructed coded block at adjacent positions to the left and/or above and/or to the upper left of the intraframe coded block, and the intraframe coded block; determining a prediction direction of the second time of intraframe prediction based on the information of the intraframe predicted block, at least one of the interframe coded blocks at adjacent positions to the right and/or beneath and/or to the lower right of the intraframe coded block, and the intraframe coded block; determining a weight coefficient of the first predicted block based on the prediction direction of the first time of intraframe prediction; and determining a weight coefficient of the second predicted block based on the prediction direction of the second time of intraframe prediction; and
the intraframe decoding unit is configured for determining the intraframe predicted block based on the first predicted block and its weight coefficient, and the second predicted block and its weight coefficient.
